(19) United States
(12) Patent Application Publication
(10) Pub. No.: US 2008/0266272 A1
(43) Pub. Date: Oct. 30, 2008

(54) Luminous touch sensor

(75) Inventors: Sujatha Narayan, Chandler, AZ (US); Robert Allen Kimball, Gilbert, AZ (US)

Correspondence Address: Paul F. Wille;Cantor Colburn LLP, 55 Griffin Road South, Bloomfield, CT, 06002, US

(73) Assignee: World Properties, Inc., Lincolnwood, IL (US)

(21) Appl. No.: 11/789,943

(22) Filed: Apr. 26, 2007

(51) Int. Cl. G06F 3/044

(52) U.S. Cl. 345/174

(57) ABSTRACT

A luminous touch sensor includes a major surface on the touch sensor, a thin plastic sheet overlying at least a portion of the major surface, and at least one light emitting diode optically coupled to the plastic sheet. The light emitting diode emits light from an edge into an edge of the plastic sheet, which acts as a light guide and redirects the light away from the major surface. The touch sensor can be opaque or transparent, with the plastic sheet positioned accordingly.

### FIELD OF THE INVENTION

This invention relates to touch sensors and, in particular, to a luminous touch sensor.

### BACKGROUND OF THE INVENTION

In a personal electronic device, such as a hand-held computer or a laptop computer, a touch sensor is often used as an input device. The touch sensor is a separate device or is built into the personal electronic device. A touch sensor uses a capacitive element or piezo-resistive element to indicate a point of contact between a user's finger and the surface of the touch sensor. The location is calculated by a microcontroller in the touch sensor or in the personal electronic device. The location, or a series of locations, is then used for control or as data entry.

In the prior art, U.S. Pat. No. 6,433,846 (Omar et al.) discloses the combination of a liquid crystal display overlying a touch sensor, wherein both are back lit by a gas discharge lamp and a light guide. U.S. Pat. No. 6,822,640 (Derocher) discloses a touch sensor back lit by an electroluminescent (EL) lamp. U.S. Pat. No. 6,842,170 (Akins et al.) discloses a liquid crystal display back lit by an EL lamp, both overlying a touch sensor. Anything overlying a touch sensor interferes with its operation. Liquid crystal displays are relatively thick and do not bend well over a short radius. Most EL lamps are relatively stiff, although urethane based lamps can be relatively flexible. A back lit piezoresistive touch sensor is currently an impossibility because known piezoresistive materials are opaque. Thus, a back lit touch sensor must be capacitive, which can be made transparent.

An EL lamp is used for back lighting because, as known in the art, the light produced by an EL lamp is very uniform across a large area. As also known in the art, an EL lamp can produce noise and requires high voltage to operate, as do gas discharge lamps. Back lit structures of the prior art are stacked elements, which are necessarily relatively thick. Not only adding to the thickness, an EL lamp is also the rear most portion of a structure, which means that the light from the lamp must pass through whatever is placed on top of the lamp. So-called transparent electrodes, e.g. for a liquid crystal display, are transparent in the sense of not substantially scattering light but they do absorb light. A transparent electrode typically absorbs twenty percent of the light passing through the electrode.

In view of the foregoing, it is therefore an object of the invention to provide a luminous touch sensor; that is, a touch sensor that emits light.

Another object of the invention is to provide a luminous touch sensor that is back lit.

A further object of the invention is to provide a luminous touch sensor that emits light from a surface that is between a user and the touch sensitive element.

Another object of the invention is to provide a luminous touch sensor that is thinner than back lit touch sensors of the prior art.

A further object of the invention is to provide a personal electronic device having a luminous touch sensor.

Another object of the invention is to provide a luminous touch sensor that does not produce noise.

A further object of the invention is to provide a luminous touch sensor that does not require high voltage or alternating current.

Another object of the invention is to provide a luminous touch sensor that is less expensive to manufacture than back lit touch sensors of the prior art.

### SUMMARY OF THE INVENTION

The foregoing objects are achieved by this invention in which a luminous touch sensor includes a touch sensor having a major surface, a light guide overlying at least a portion of the major surface, and at least one light emitting diode optically coupled to the light guide. The light emitting diode is preferably an edge emitter and the plastic sheet is preferably relatively thin.

### BRIEF DESCRIPTION OF THE DRAWINGS

A more complete understanding of the invention can be obtained by considering the following detailed description in conjunction with the accompanying drawings, in which:

FIG. 1 is a cross-section of a back lit touch sensor constructed in accordance with the prior art;

FIG. 2 is a cross-section of a luminous touch sensor constructed in accordance with a preferred embodiment of the invention;

FIG. 3 is a cross-section of a luminous touch sensor constructed in accordance with an alternative embodiment of the invention;

FIG. 4 is a plan view of a light guide for use in a luminous touch sensor constructed in accordance with a preferred embodiment of the invention;

FIG. 5 is a perspective view of a personal electronic device including a luminous touch sensor constructed in accordance with a preferred embodiment of the invention.

### DETAILED DESCRIPTION OF THE INVENTION

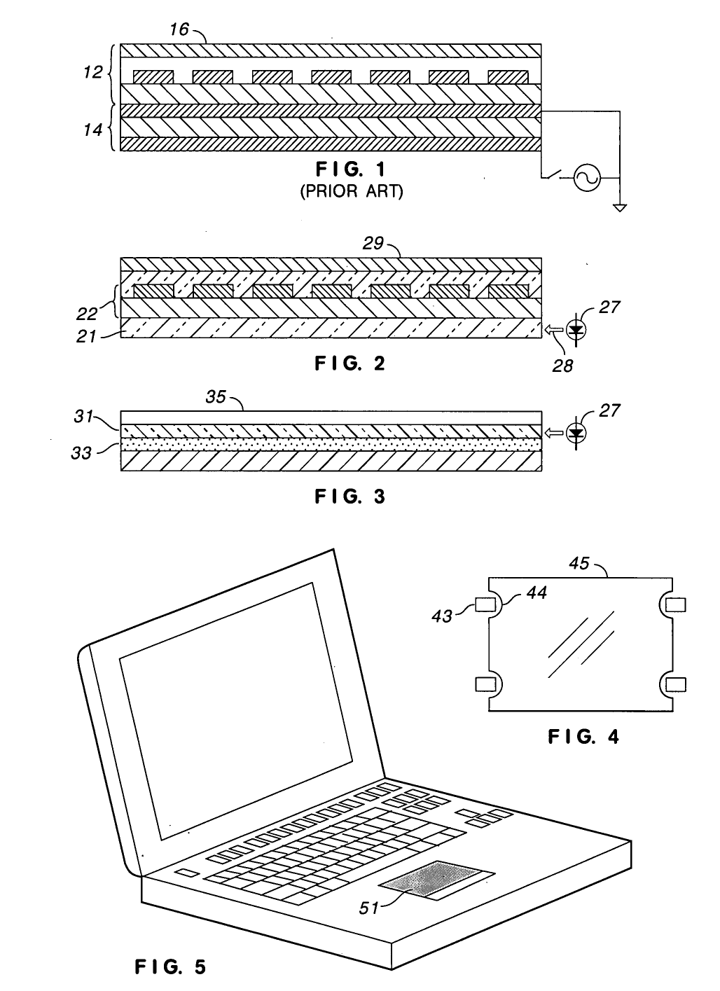

Except for reference numerals, FIG. 1 is the same as FIG. 5 in U.S. Pat. No. 6,822,640 (Derocher). In FIG. 1, touch sensor 12 is back lit by EL lamp 14. Protective layer 16 overlies the upper surface of touch sensor 12. As noted above, the stack of elements is relatively thick and the light emitted by EL lamp 14 must pass through touch sensor 12.

In FIG. 2, light guide 21 is a sheet in contact with a major surface of touch sensor 22. Light guide 21 is preferably a layer of plastic film such as polyester or polycarbonate having a thickness of 0.2 mm or less. Light emitting diode (LED) 27 is preferably an edge emitting LED. Thus, both the LED and the light guide are relatively thin. Light from LED 26 is scattered upwardly (as oriented in the drawing) by light guide 21. Scattering, as known in the art, can be obtained by roughening the upper surface of light guide 21 or by including small light scattering particles in light guide 21. Optional protective layer 29 overlies touch screen 22 and is screen printed or applied as a layer. Layer 29 optionally includes graphics or an optical mask for creating a particular visual effect.

In operation, power is supplied to LED 27, which preferentially emits light in a direction indicated by arrow 28, into light guide 21. The light spreads through light guide 21 by transmission and by total internal reflection from the major surfaces of the light guide. Some light is scattered toward a user, e.g., by roughening an area of the upper surface of the light guide to cause refraction rather than total internal reflection.

In FIG. 3, light guide 31 overlies piezoresistive sheet 33. Light from LED 27 is spread by light guide 31 in the same manner as light is spread by light guide 21 (FIG. 2). Optional protective layer 35 overlies light guide 31 and is screen printed or applied as a layer. Layer 35 optionally includes graphics or an optical mask for creating a particular visual effect.

As illustrated in FIG. 4, the number and placement of the LEDs depends upon the size of the touch sensor and the refractive index of the light guide. Preferably, each LED is mounted in a small recess, such as LED 43 in recess 44. This enables light guide 45 to capture as much light as possible.

In FIGS. 3 and 4, it is presumed that the user is viewing the touch sensor from above, as the touch sensor is oriented in the figures. In FIGS. 3 and 4, the light guide “overlies” the touch sensor whether the light guide is above the touch sensor or below the touch sensor. No limitation on the making of a luminous touch sensor in accordance with the invention is made or intended. For example, during manufacture, light guide 21 can be laminated to, i.e. overlie, the upper surface of touch sensor 22 and the combination then turned over for further treatment, producing the device illustrated in FIG. 2.

FIG. 5 is a perspective view of a laptop computer including a luminous touch sensor constructed in accordance with a preferred embodiment of the invention. Touch sensor 51 can be made luminous whenever there is contact or be luminous continuously during low light level conditions, such as during flight on an airplane. The brightness can be fixed, manually adjustable, or automatically adjustable to suit ambient lighting level.

The invention thus provides a luminous touch sensor. The luminous touch sensor is thinner than back lit touch sensors of the prior art and is suitable for any type of personal electronic device. A luminous touch sensor constructed in accordance with the invention does not require high voltage or alternating current and does not emit noise. The light guide can be behind or in front of the touch sensing element, enabling the invention to be used with a wider variety of touch sensors than in the prior art. Because of the fewer elements involved, a touch sensor constructed in accordance with the invention is simpler and less expensive to make.

Having thus described the invention, it will be apparent to those of skill in the art that various modifications can be made within the scope of the invention. For example, the LED can have any desired color or, if plural LEDs are used, any combination of colors. Protective layer 29 can be transparent, translucent, tinted or include graphics, in any combination.

What is claimed is:

1. A luminous touch sensor comprising:
a touch sensor having a major surface;
a plastic sheet overlying at least a portion of said major surface;
at least one light emitting diode optically coupled to said plastic sheet whereby said light emitting diode emits light into the plastic sheet, which redirects the light away from said surface.

2. The luminous touch sensor as set forth in claim 1 wherein said light emitting diode is an edge emitting diode.

3. The luminous touch sensor as set forth in claim 1 wherein said plastic sheet includes an edge recess for receiving said light emitting diode.

4. The luminous touch sensor as set forth in claim 1 including at least two light emitting diodes located along the periphery of said plastic sheet.

5. The luminous touch sensor as set forth in claim 1 wherein said plastic sheet has a thickness on the order of 0.2 mm or less.

6. The luminous touch sensor as set forth in claim 1 wherein said plastic sheet is selected from the group consisting of polyester and polycarbonate.

7. The luminous touch sensor as set forth in claim 1 wherein said touch sensor is capacitive and light is emitted through the touch sensor.

8. The luminous touch sensor as set forth in claim 1 wherein said touch sensor is resistive and light is emitted from above the touch sensor.

9. A personal electronic device characterized by including the luminous touch sensor as set forth in claim 1.
